(19) United States
(12) Patent Application Publication
(10) Pub. No.: US 2014/0324546 A1
(43) Pub. Date: Oct. 30, 2014

(54) SIMULTANEOUS RETAIL AND TRANSFER PRICE OPTIMIZATIONS

(71) Applicant: International Business Machines Corporation, (US)

(72) Inventors: Nuri M. Gokhan, San Mateo, CA (US); Yunfei Jing, Shanghai (CN); Haifang Li, Shanghai (CN); Ngoc-Lan I. Phan, Burlingame, CA (US); Susan A. Rasiah, San Carlos, CA (US); Siqun Wang, San Carlos, CA (US); Beibei Ye, Fremont, CA (US)

(73) Assignee: International Business Machines Corporation, Armonk, NY (US)

(21) Appl. No.: 13/870,539

(22) Filed: Apr. 25, 2013

(51) Int. Cl. G06Q 30/02

(52) U.S. Cl. CPC G06Q 30/0206
USPC 705/7.35

(57) ABSTRACT

A request for a simultaneous retail and transfer price optimization is received. The request includes a mutual optimization goal of each of at least two participants of a supply chain. Simultaneous optimization input constraints are selected based upon the mutual optimization goal. The requested simultaneous retail and transfer price optimization is performed using the selected simultaneous optimization input constraints. A set of optimized values of the mutual optimization goal is determined, based upon the simultaneous retail and transfer price optimization, using the selected simultaneous optimization input constraints. Each value of the set of optimized values is associated with one of the at least two participants of the supply chain. Output is generated that identifies the determined set of optimized values of the mutual optimization goal.

### BACKGROUND

The present invention relates to price optimization. More particularly, the present invention relates to simultaneous retail and transfer price optimizations.

Franchisors and other distributors of goods transfer products to franchisees or other retailers. The franchisees or other retailers sell the goods in the market to purchasers. The purchasers may utilize the products purchased and may purchase additional products in the future.

### BRIEF SUMMARY

A method includes receiving, at a processor, a request for a simultaneous retail and transfer price optimization, where the request for the simultaneous retail and transfer price optimization comprises a mutual optimization goal of each of at least two participants of a supply chain; selecting simultaneous optimization input constraints based upon the mutual optimization goal; performing the requested simultaneous retail and transfer price optimization using the selected simultaneous optimization input constraints; determining, based upon the simultaneous retail and transfer price optimization using the selected simultaneous optimization input constraints, a set of optimized values of the mutual optimization goal, where each value of the set of optimized values is associated with one of the at least two participants of the supply chain; and generating output that identifies the determined set of optimized values of the mutual optimization goal.

A system includes a memory that stores simultaneous optimization input constraints, and a processor programmed to: receive a request for a simultaneous retail and transfer price optimization, where the request for the simultaneous retail and transfer price optimization comprises a mutual optimization goal of each of at least two participants of a supply chain; select the simultaneous optimization input constraints from the memory based upon the mutual optimization goal; perform the requested simultaneous retail and transfer price optimization using the selected simultaneous optimization input constraints; determine, based upon the simultaneous retail and transfer price optimization using the selected simultaneous optimization input constraints, a set of optimized values of the mutual optimization goal, where each value of the set of optimized values is associated with one of the at least two participants of the supply chain; and generate output that identifies the determined set of optimized values of the mutual optimization goal.

A computer program product includes a computer readable storage medium having computer readable program code embodied therewith, where the computer readable program code when executed on a computer causes the computer to receive a request for a simultaneous retail and transfer price optimization, where the request for the simultaneous retail and transfer price optimization comprises a mutual optimization goal of each of at least two participants of a supply chain; select simultaneous optimization input constraints based upon the mutual optimization goal; perform the requested simultaneous retail and transfer price optimization using the selected simultaneous optimization input constraints; determine, based upon the simultaneous retail and transfer price optimization using the selected simultaneous optimization input constraints, a set of optimized values of the mutual optimization goal, where each value of the set of optimized values is associated with one of the at least two participants of the supply chain; and generate output that identifies the determined set of optimized values of the mutual optimization goal.

### BRIEF DESCRIPTION OF THE SEVERAL VIEWS OF THE DRAWINGS

FIG. 1 is a block diagram of an example of an implementation of a system for simultaneous retail and transfer price optimizations according to an embodiment of the present subject matter;

FIG. 2 is a block diagram of an example of an implementation of a core processing module capable of performing simultaneous retail and transfer price optimizations according to an embodiment of the present subject matter;

FIG. 3 is a flow chart of an example of an implementation of a process for simultaneous retail and transfer price optimizations according to an embodiment of the present subject matter; and

FIG. 4 is a flow chart of an example of an implementation of a process for simultaneous retail and transfer price optimizations according to an embodiment of the present subject matter.

### DETAILED DESCRIPTION

The examples set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The subject matter described herein provides simultaneous retail and transfer price optimizations. The subject matter described herein manages optimization of supply chain prices at each transfer point (e.g., franchisor transfer prices to franchisee, and franchisee retailer prices, etc.) to improve/maximize the profit of the franchisor, franchisee, and/or both parties. The subject matter described herein differs from conventional price optimizations in its evaluation of retailer pricing optimization from a retailer's perspective by optimization of “transfer” prices (e.g., the price that a franchisor charges its franchisees) in the supply chain. The subject matter described herein manages optimization of both the franchisor prices and the franchisee prices simultaneously to improve/maximize the profit for the franchisor, for the franchisee, or for all participants within the overall system, while satisfying a set of pricing rules that apply to franchisee and franchisor prices separately or jointly.

A set of pricing rules may be defined by users of the present technology (e.g., each of franchisors and franchisees) to limit the price change behavior of the simultaneous price optimizations, while trying to determine the highest profit, highest revenue, or highest volume generating set of prices across the supply chain. The present subject matter manages an additional layer of pricing, such as where a franchisor sells its products to its franchisees at a certain price point (“transfer price” herein) with the intent of making an intended profit. The franchisees then set their prices (“retail price” herein) by adding their intended profit margins on top of the transfer price based on their agreements with franchisor. The present subject matter simultaneously optimizes both the transfer prices and the retail prices, while managing the pricing rules defined for either price (e.g., transfer or retail) and between the entities for compliance with the designated pricing rules.

The present technology operates by obtaining initial zone prices (where a zone for a retailer is a set of stores) for both the transfer price and the retail price, as well as all pricing rules defined for each price and between the participants. As the optimization proceeds, both prices are changed simultaneously and evaluated with respect to a stated objective/goal (e.g., a simultaneous price optimization goal of profit, revenue, sales volume, etc.) to maximize the stated objective across all entities while ensuring that the designated pricing rules are satisfied. The objective/goal may be considered a mutual optimization goal, such that a respective objective (e.g., maximized profit, revenue, sales volume, etc.) is applicable to multiple entities/participants in the supply chain. For example, where profit is indicated to be the goal to be maximized, the profit of a franchisor and the profit of a franchisee are jointly maximized. Similarly, for revenue or sales volume, the respective quantities may be jointly maximized across the set of participants. Additionally, the mutual optimization goal may have different components of interest to each party, such as to maximize profit for a franchisor, while ensuring a certain profit margin for a franchisee. Many other possibilities exist for configuration of mutual optimization goals and all such possibilities are considered to be within the scope of the present subject matter.

The following description illustrates an example implementation of a mutual optimization goal with one variable maximized and another variable regulated within a specified range. For purposes of the present example, it is assumed that the mutual optimization goal is to identify an optimized decision with respect to a transfer price and a retail price that maximizes a franchisor's profit, subject to satisfaction of all defined pricing rules. One such defined pricing rule is to ensure at least a twenty percent (20%) gross margin (GM) for the franchisee retailers as a business incentive. Within the present example, it is assumed that this multiple goal optimization results in two sets of decisions that have the following results, as represented within the following Table 1.

TABLE 1
Example Decision Set

| | Franchisor's | Franchisee's | Franchisee's Gross |
|---|---|---|---|
| Decision Set | Profit | Profit | Margin (GM) |
| Set 1 | $1,000.00 | $330.00 | 30% |
| Set 2 | $1,100.00 | $200.00 | 20% |

Using these example decision sets (Set 1 and Set 2), it may be seen that both decision sets satisfy the “at least 20% GM requirement” for the franchisee retailer. Specifically, the first decision set (Set 1) has a thirty percent (30%) GM for the franchisee, and the second decision set (Set 2) has a twenty percent (20%) GM for the franchisee. However, it is also noted that the franchisor's profit is greater with the second decision set (Set 2), with a total profit for the franchisor of one thousand one hundred dollars ($1,100.00). By comparison, the franchisor's profit is less with the first decision set (Set 1), with a total profit for the franchisor of one thousand dollars ($1,000.00). As such, the second decision set (Set 2) provides the better solution to this particular multi-variable problem. It is additionally noted that the total profit (though not shown in Table 1 of the first decision set (Set 1)) is one thousand three hundred thirty dollars ($1,330.00), while the total profit of the second decision set (Set 2) is one thousand three hundred dollars ($1,300.00). As such, where the specified mutual goal is to maximize the franchisor's profit and to ensure the franchisee's GM specification of twenty percent (20%), the second decision set (Set 2) results in the franchisor's profit being maximized, rather than the total profit of both parties, though other constraints may be encoded into pricing rules to vary the output as appropriate for a given implementation.

As this example further illustrates, a mutual goal may be set for one party optimization (e.g., maximize the franchisor's own interest, such as profit, revenue, etc.), where the franchisee retailer's interest (profit, margin, etc.) may be ensured to be at a certain level without requiring optimization of both variables as long as the solution chosen satisfies all defined pricing rules, subject to any rule relaxation as described in more detail below. It should be noted that, while the present example prioritizes the franchisor's profits, any other permutation of criteria may be used as appropriate for a given implementation.

Because of a potential for conflicts between pricing rules defined by different entities, users may configure/define rule hierarchies that specify an importance/priority for the respective pricing rules. The defined rule hierarchies, or the rules themselves, may be defined to include pricing rule relaxation criteria that specify a degree of flexibility in rule compliance for situations where there may be a pricing rule conflict. Based on the user-defined rule hierarchy, rules may be relaxed when they conflict within the pre-defined relaxation criteria to concurrently satisfy the designated pricing rules. Profit forecasts, revenue forecasts, sales volume forecasts, and other outputs may be generated based upon simultaneously optimized prices across the supply chain and the stated objective(s). The optimal prices (both transfer and retail) may be exported/outputted to users along with the profit forecasts, revenue forecasts, and/or sales volume forecasts that are calculated using the determined optimized prices.

It should be noted that conception of the present subject matter resulted from recognition of certain limitations associated with maximizing profits for multiple entities, such as franchisees/franchisors, that are mutually interested in each entity making profits sufficient to motivate each party to continue the relationship. For example, it was observed that conventional price optimizations for supply chains only allow users to determine one price optimization in the chain at a time and require the users to “set” or “fix” as a constant value all other price points. It was determined that these conventional optimizations result in sub-optimal solutions because the set or fixed constant prices are not evaluated to determine whether these prices help to contribute to profits for all participants across the supply chain. As such, it was further determined that an approach to simultaneously optimize all prices across a supply chain (e.g., franchisor transfer prices to franchisees, franchisee retail prices, etc.) may be used to evaluate and improve profits for all participants in a supply chain. It was further observed that franchisor/franchisee supply chains often included thousands of retail outlets/franchisees. It was determined that simultaneous price optimization technology, as described herein, for determining optimal prices across a supply chain may accommodate thousands of retail and transfer price points that are derived from supply chain transfers to maximize profits for potentially several thousand participants. The present subject matter improves pricing optimization for increased profits for all participants across a supply chain by providing for simultaneous retail and transfer price optimizations, as described above and in more detail below. As such, improved profits for multiple parties in a supply chain may be obtained through use of the technology described herein.

The simultaneous retail and transfer price optimizations described herein may be performed in real time to allow prompt optimization of multiple prices charged by different participants in a supply chain to improve profits for all participants. For purposes of the present description, real time shall include any time frame of sufficiently short duration as to provide reasonable response time for information processing acceptable to a user of the subject matter described. Additionally, the term “real time” shall include what is commonly termed “near real time”—generally meaning any time frame of sufficiently short duration as to provide reasonable response time for on-demand information processing acceptable to a user of the subject matter described (e.g., within a portion of a second or within a few seconds). These terms, while difficult to precisely define are well understood by those skilled in the art.

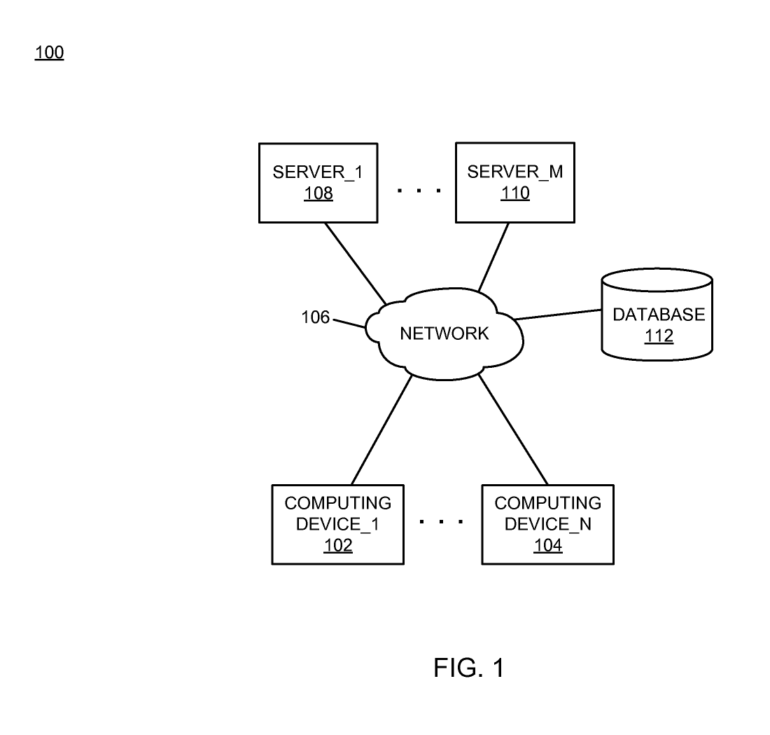

FIG. 1 is a block diagram of an example of an implementation of a system 100 for simultaneous retail and transfer price optimizations. A computing device_{—}1 102 through a computing device_N 104 communicate via a network 106 with several other devices. The other devices include a server_{—}1 108 through a server_M 110. Each of the respective devices may also interact with a database 112 to store and retrieve data.

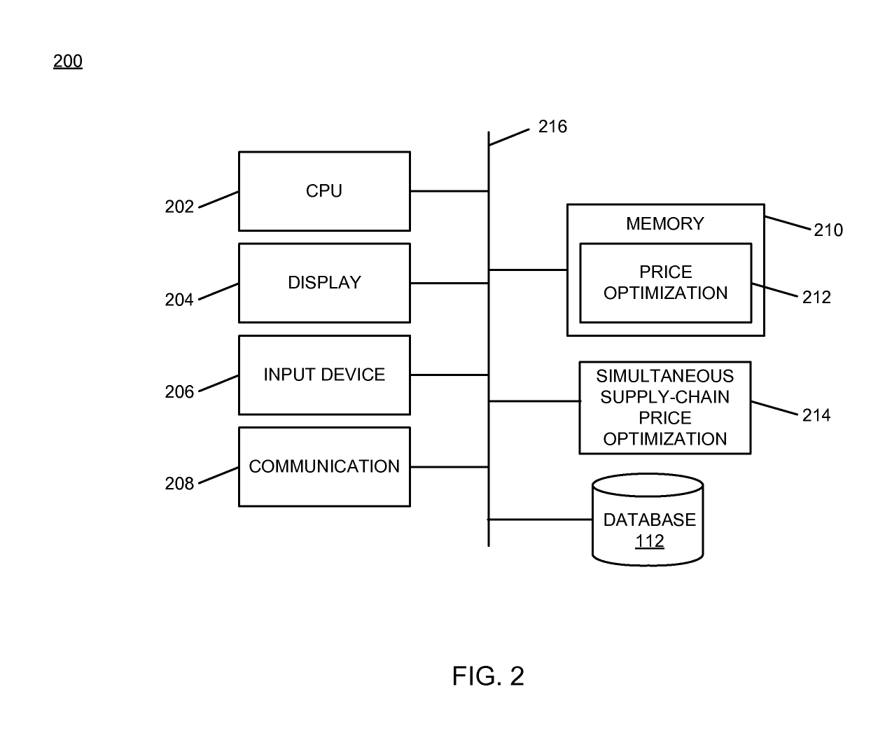

As will be described in more detail below in association with FIG. 2 through FIG. 4, the computing device_{—}1 102 through the computing device_N 104 and the server_{—}1 108 through the server_M 110 may each provide automated simultaneous retail and transfer price optimizations. The automated simultaneous retail and transfer price optimizations is based upon concurrent evaluation of multiple prices charged by multiple parties across a supply chain to determine a price for each transfer (e.g., transfer price from franchisor to franchisee, retail price from franchisee to consumer, etc.). As such, the present technology may be implemented at a user computing device or server device level. A variety of possibilities exist for implementation of the present subject matter, and all such possibilities are considered within the scope of the present subject matter.

It should be noted that any of the respective computing devices described in association with FIG. 1 may be portable computing devices, either by a user's ability to move the respective computing devices to different locations, or by the respective computing device's association with a portable platform, such as a plane, train, automobile, or other moving vehicle. It should also be noted that the respective computing devices may be any computing devices capable of processing information as described above and in more detail below. For example, the respective computing devices may include devices such as a personal computer (e.g., desktop, laptop, etc.) or a handheld device (e.g., cellular telephone, personal digital assistant (PDA), email device, music recording or playback device, tablet computing device, e-book reading device, etc.), a web server, application server, or other data server device, or any other device capable of processing information as described above and in more detail below.

The network 106 may include any form of interconnection suitable for the intended purpose, including a private or public network such as an intranet or the Internet, respectively, direct inter-module interconnection, dial-up, wireless, or any other interconnection mechanism capable of interconnecting the respective devices.

The server_{—}1 108 through the server_M 110 may include any device capable of providing data for consumption by a device, such as the computing device_{—}1 102 through the computing device_N 104, via a network, such as the network 106. As such, the server_{—}1 108 through the server_M 110 may each include a web server, application server, or other data server device.

The database 112 may include a relational database, an object database, or any other storage type of device. As such, the database 112 may be implemented as appropriate for a given implementation.

FIG. 2 is a block diagram of an example of an implementation of a core processing module 200 capable of performing simultaneous retail and transfer price optimizations. The core processing module 200 may be associated with either the computing device_{—}1 102 through the computing device_N 104 or with the server_{—}1 108 through the server_M 110, as appropriate for a given implementation. As such, the core processing module 200 is described generally herein, though it is understood that many variations on implementation of the components within the core processing module 200 are possible and all such variations are within the scope of the present subject matter.

Further, the core processing module 200 may provide different and complementary processing for optimization of multiple simultaneous transfer prices across a supply chain in association with each implementation. As such, for any of the examples below, it is understood that any aspect of functionality described with respect to any one device that is described in conjunction with another device (e.g., sends/sending, etc.) is to be understood to concurrently describe the functionality of the other respective device (e.g., receives/receiving, etc.).

A central processing unit (CPU) 202 provides computer instruction execution, computation, and other capabilities within the core processing module 200. A display 204 provides visual information to a user of the core processing module 200 and an input device 206 provides input capabilities for the user.

The display 204 may include any display device, such as a cathode ray tube (CRT), liquid crystal display (LCD), light emitting diode (LED), electronic ink displays, projection, touchscreen, or other display element or panel. The input device 206 may include a computer keyboard, a keypad, a mouse, a pen, a joystick, touchscreen, or any other type of input device by which the user may interact with and respond to information on the display 204.

A communication module 208 provides interconnection capabilities that allow the core processing module 200 to communicate with other modules within the system 100. The communication module 208 may include any electrical, protocol, and protocol conversion capabilities useable to provide interconnection capabilities, appropriate for a given implementation.

A memory 210 includes a price optimization storage area 212 that stores price information, pricing rules, optimized price determinations, and other information associated with supply chains, such as franchisor and franchisee business environments, in association with core processing module 200. As will be described in more detail below, information stored within the price optimization storage area 212 is used to perform simultaneous determinations of optimized prices across a supply chain. The information stored within the price optimization storage area 212 is also used to provide output including profit forecasts, revenue forecasts, and/or sales volume forecasts that are calculated using the determined optimized prices, including the retail prices that consumers would be charged in the retail outlets, as described above.

It is understood that the memory 210 may include any combination of volatile and non-volatile memory suitable for the intended purpose, distributed or localized as appropriate, and may include other memory segments not illustrated within the present example for ease of illustration purposes. For example, the memory 210 may include a code storage area, an operating system storage area, a code execution area, and a data area without departure from the scope of the present subject matter.

A simultaneous supply-chain price optimization module 214 is also illustrated. The simultaneous supply-chain price optimization module 214 provides concurrent price optimizations of both transfer and retail prices to maximize a goal specified by the user (e.g., profit, revenue, sales volume, etc.) for the core processing module 200, as described above and in more detail below. The simultaneous supply-chain price optimization module 214 implements the automated simultaneous retail and transfer price optimizations of the core processing module 200.

It should also be noted that the simultaneous supply-chain price optimization module 214 may form a portion of other circuitry described without departure from the scope of the present subject matter. Further, the simultaneous supply-chain price optimization module 214 may alternatively be implemented as an application stored within the memory 210. In such an implementation, the simultaneous supply-chain price optimization module 214 may include instructions executed by the CPU 202 for performing the functionality described herein. The CPU 202 may execute these instructions to provide the processing capabilities described above and in more detail below for the core processing module 200. The simultaneous supply-chain price optimization module 214 may form a portion of an interrupt service routine (ISR), a portion of an operating system, a portion of a browser application, or a portion of a separate application without departure from the scope of the present subject matter.

The database 112 is again shown within FIG. 2 associated with the core processing module 200. As such, the database 112 may be operatively coupled to the core processing module 200 without use of network connectivity, as appropriate for a given implementation.

The CPU 202, the display 204, the input device 206, the communication module 208, the memory 210, the simultaneous supply-chain price optimization module 214, and the database 112 are interconnected via an interconnection 216. The interconnection 216 may include a system bus, a network, or any other interconnection capable of providing the respective components with suitable interconnection for the respective purpose.

Though the different modules illustrated within FIG. 2 are illustrated as component-level modules for ease of illustration and description purposes, it should be noted that these modules may include any hardware, programmed processor(s), and memory used to carry out the functions of the respective modules as described above and in more detail below. For example, the modules may include additional controller circuitry in the form of application specific integrated circuits (ASICs), processors, antennas, and/or discrete integrated circuits and components for performing communication and electrical control activities associated with the respective modules. Additionally, the modules may include interrupt-level, stack-level, and application-level modules as appropriate. Furthermore, the modules may include any memory components used for storage, execution, and data processing for performing processing activities associated with the respective modules. The modules may also form a portion of other circuitry described or may be combined without departure from the scope of the present subject matter.

Additionally, while the core processing module 200 is illustrated with and has certain components described, other modules and components may be associated with the core processing module 200 without departure from the scope of the present subject matter. Additionally, it should be noted that, while the core processing module 200 is described as a single device for ease of illustration purposes, the components within the core processing module 200 may be co-located or distributed and interconnected via a network without departure from the scope of the present subject matter. For a distributed arrangement, the display 204 and the input device 206 may be located at a point of sale device, kiosk, or other location, while the CPU 202 and memory 210 may be located at a local or remote server. Many other possible arrangements for components of the core processing module 200 are possible and all are considered within the scope of the present subject matter. It should also be understood that, though the database 112 is illustrated as a separate component for purposes of example, the information stored within the database 112 may also/alternatively be stored within the memory 210 without departure from the scope of the present subject matter. Accordingly, the core processing module 200 may take many forms and may be associated with many platforms.

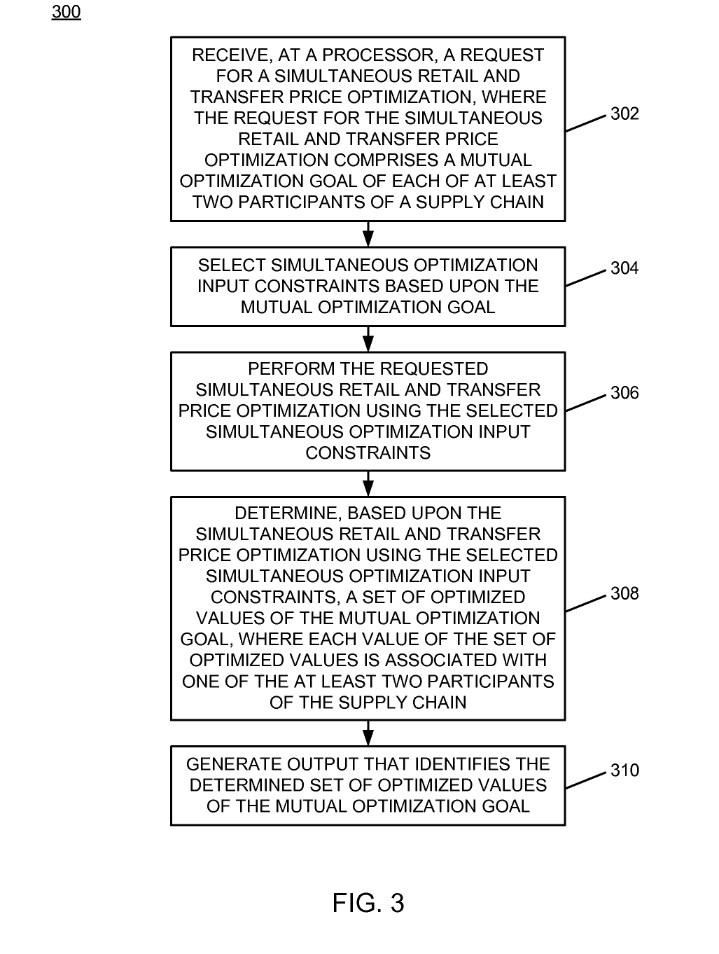

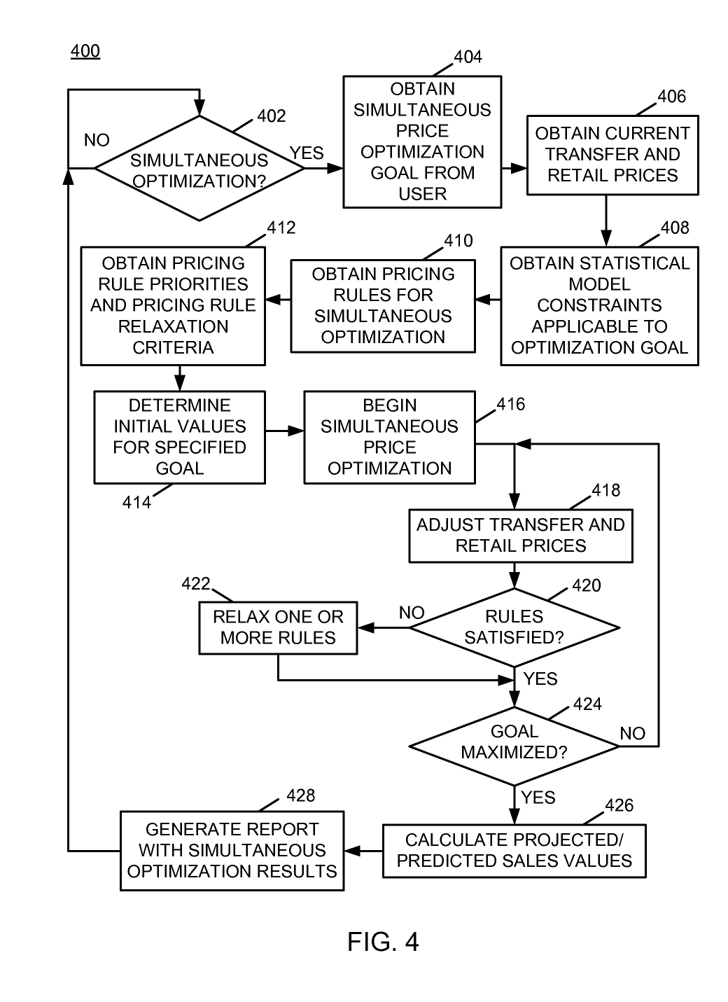

FIG. 3 through FIG. 4 described below represent example processes that may be executed by devices, such as the core processing module 200, to perform the automated simultaneous retail and transfer price optimizations associated with the present subject matter. Many other variations on the example processes are possible and all are considered within the scope of the present subject matter. The example processes may be performed by modules, such as the simultaneous supply-chain price optimization module 214 and/or executed by the CPU 202, associated with such devices. It should be noted that time out procedures and other error control procedures are not illustrated within the example processes described below for ease of illustration purposes. However, it is understood that all such procedures are considered to be within the scope of the present subject matter. Further, the described processes may be combined, sequences of the processing described may be changed, and additional processing may be added or removed without departure from the scope of the present subject matter.

FIG. 3 is a flow chart of an example of an implementation of a process 300 for simultaneous retail and transfer price optimizations. At block 302, the process 300 receives, at a processor, a request for a simultaneous retail and transfer price optimization, where the request for the simultaneous retail and transfer price optimization comprises a mutual optimization goal of each of at least two participants of a supply chain. At block 304, the process 300 selects simultaneous optimization input constraints based upon the mutual optimization goal. At block 306, the process 300 performs the requested simultaneous retail and transfer price optimization using the selected simultaneous optimization input constraints. At block 308, the process 300 determines, based upon the simultaneous retail and transfer price optimization using the selected simultaneous optimization input constraints, a set of optimized values of the mutual optimization goal, where each value of the set of optimized values is associated with one of the at least two participants of the supply chain. At block 310, the process 300 generates output that identifies the determined set of optimized values of the mutual optimization goal.

FIG. 4 is a flow chart of an example of an implementation of a process 400 for simultaneous retail and transfer price optimizations. At decision point 402, the process 400 makes a determination as to whether a request to perform simultaneous price optimization has been detected, such as from a user via the input device 206. Additionally, all inputs from the user may be obtained interactively using the display 204 and the input device 206, or may be obtained from configuration information stored within the database 112 or the price optimization storage area 212 of the memory 210.

In response to determining that a request to perform simultaneous price optimization has been detected, the process 400 obtains a simultaneous price optimization goal (e.g., output objective) at block 404. The goal may be considered a mutual optimization goal, where a specified financial value is designated to be optimized for multiple participants of the respective supply chain (e.g., maximize profits for both a franchisor and franchisee). As described above, the simultaneous price optimization goal may be specified, for example, to include profit maximization, revenue maximization, sales volume maximization, or otherwise as appropriate for a given implementation. Additionally, the initial request for the simultaneous retail and transfer price optimization may include the mutual optimization goal. At block 406, the process 400 obtains current prices for both transfer (e.g., franchisor prices) and retail (e.g., franchisee prices).

At block 408, the process 400 obtains statistical model constraints applicable to the specified mutual optimization goal. The statistical model constraints applicable to the specified goal may be selected based upon the indicated value (e.g., profit, revenue, sales, etc.) specified in association with the mutual optimization goal. For example, statistical models may be stored in the database 112 that detail price elasticity for various products, that detail impacts of promotional activities (e.g., advertising) on sales, that detail historical data of pricing and price fluctuations, and that detail other data. The obtained statistical model constraints applicable to the specified goal may be utilized during the simultaneous optimization of prices across a supply chain to characterize/evaluate effectiveness of any simultaneously-optimized pricing strategy during any iteration of the optimization.

At block 410, the process 400 obtains a set of pricing rules to be enforced during the simultaneous retail and transfer price optimization of prices across the supply chain. The set of pricing rules may be selected based upon the indicated value (e.g., profit, revenue, sales, etc.) specified in association with the mutual optimization goal. For example, a pricing rule may be specified such that a simultaneous price optimization results in a twenty percent (20%) profit for a franchisor at the transfer price. Another pricing rule may be specified such that a simultaneous price optimization results in a twenty percent (20%) profit for a franchisee at the retail price. Further, a pricing rule may be specified such that national and private brands are competitively priced, and that the private brand is twenty percent (20%) less expensive than the national brand. Many other forms of pricing rules are possible and all are considered within the scope of the present subject matter.

At block 412, the process 400 obtains pricing rule priorities and pricing rule relaxation criteria. The pricing rule priorities and pricing rule relaxation criteria may also be selected based upon the indicated value (e.g., profit, revenue, sales, etc.) specified in association with the mutual optimization goal. As described above, the pricing rules may be hierarchically prioritized for optimization compliance. Further, as described above, the pricing rules may be specified by priorities within the pricing rules, including pricing rule relaxation criteria that specify a degree of flexibility in rule compliance for situations of pricing rule conflict. The pricing rule relaxation criteria may be specified in any manner appropriate for a given implementation.

At block 414, the process 400 determines initial values for the specified goal. The initial values may be initial profit values, initial revenue values, and/or initial sales volume values for each participant in the supply chain, etc., as appropriate for the specified goal of the simultaneous optimization. The initial values for the specified goal may be obtained, for example, from the price optimization storage area 212, the database 112, or may be calculated based upon the statistical model information, as appropriate for a given implementation.

At block 416, the process 400 begins the simultaneous price optimization using the obtained current transfer and retail prices. It should be understood that the simultaneous optimization may be considered an iterative process to refine simultaneous price optimizations by varying prices as appropriate to optimize the stated optimization goal for all participants (e.g., profit maximization, revenue maximization, sales volume maximization, etc.). At block 418, the process 400 adjusts the transfer and retail prices (e.g., the initial obtained prices for the first iteration, or adjusted prices for subsequent iterations). It should be noted that, as part of the mutual/simultaneous optimization, the transfer price and the retail price are adjusted as a pair, and as described in more detail below, these two values are iteratively adjusted to identify a mutual maximum at a particular set of values for the pair.

At decision point 420, the process 400 makes a determination as to whether the pricing rules may be satisfied at the adjusted prices. As described above, the pricing rules may be considered and selected as simultaneous optimization input constraints. If all rules are not satisfied, this situation may be considered a pricing rule conflict. In response to determining that the pricing rules may not be satisfied at the adjusted prices, the process 400 relaxes one or more of the pricing rules based upon any pricing rule relaxation criteria that specify a degree of flexibility in rule compliance for situations of pricing rule conflict at block 422.

In response to either relaxing one or more of the pricing rules at block 422, or in response to determining that the pricing rules are satisfied at the adjusted prices at decision point 420, the process 400 makes a determination at decision point 424 as to whether the mutual optimization goal has been maximized at the adjusted transfer and retail prices. For purposes of example, a determination that the mutual optimization goal has been maximized at the adjusted transfer and retail prices may be made where the objective/goal has reached a maximum value and does not increase further, at which point the adjusted transfer and retail prices may be selected as the optimized values for the respective prices. Similarly, a determination that the goal has not been maximized at the adjusted transfer and retail prices may be made where the objective/goal increases during a given iteration of the simultaneous price optimization, or that the objective/goal decreases during a given iteration of the simultaneous price optimization. As such, where the process 400 determines that the goal has not been maximized at the adjusted transfer and retail prices, the process 400 returns to block 418 to further adjust the transfer and retail prices, and iterates as described above.

In response to determining at decision point 424 that the goal has been maximized at the adjusted transfer and retail prices, the simultaneous price optimization portion of the process 400 may be considered completed. The process 400 calculates projected/predicted sales values (e.g., quantities sold, profits, etc.) based upon the simultaneously optimized transfer and retail prices at block 426. At block 428, the process 400 generates a report including the simultaneous transfer and retail price optimizations, the projected/predicted sales values, and other information as appropriate for a given implementation. The report may be output to the display 204, stored to the price optimization storage area 212, stored to the database 112, or otherwise provided to the user that requested the simultaneous retail and transfer price optimization, as appropriate for a given implementation. The process 400 returns to decision point 402 and iterates as described above.

As such, the process 400 obtains a set of inputs that include a simultaneous price optimization goal related to both transfer and retail prices within a supply chain, initial transfer and retail prices, statistical pricing information, and pricing rules/priorities and pricing rule relaxation criteria. The process 400 performs a simultaneous optimization of the transfer and retail prices. The process 400 calculates projected/predicted sales values (e.g., quantities sold, profits, etc.), and provides those values to the user.

As described above in association with FIG. 1 through FIG. 4, the example systems and processes provide simultaneous retail and transfer price optimizations. Many other variations and additional activities associated with simultaneous retail and transfer price optimizations are possible and all are considered within the scope of the present subject matter.

Those skilled in the art will recognize, upon consideration of the above teachings, that certain of the above examples are based upon use of a programmed processor, such as the CPU 202. However, the invention is not limited to such example embodiments, since other embodiments could be implemented using hardware component equivalents such as special purpose hardware and/or dedicated processors. Similarly, general purpose computers, microprocessor based computers, micro-controllers, optical computers, analog computers, dedicated processors, application specific circuits and/or dedicated hard wired logic may be used to construct alternative equivalent embodiments.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as JAVA, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable storage medium that can direct a computer or other programmable data processing apparatus to function in a particular manner, such that the instructions stored in the computer-readable storage medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
receiving, at a processor, a request for a simultaneous retail and transfer price optimization, where the request for the simultaneous retail and transfer price optimization comprises a mutual optimization goal of each of at least two participants of a supply chain;
selecting simultaneous optimization input constraints based upon the mutual optimization goal;
performing the requested simultaneous retail and transfer price optimization using the selected simultaneous optimization input constraints;
determining, based upon the simultaneous retail and transfer price optimization using the selected simultaneous optimization input constraints, a set of optimized values of the mutual optimization goal, where each value of the set of optimized values is associated with one of the at least two participants of the supply chain; and
generating output that identifies the determined set of optimized values of the mutual optimization goal.

2. The method of claim 1, where selecting the simultaneous optimization input constraints based upon the mutual optimization goal comprises:
obtaining current prices of both a transfer price and a retail price;
obtaining statistical model constraints applicable to the mutual optimization goal;
obtaining a set of pricing rules to be enforced during the simultaneous retail and transfer price optimization of prices across the supply chain; and
obtaining pricing rule priorities and pricing rule relaxation criteria.

3. The method of claim 1, where performing the requested simultaneous retail and transfer price optimization using the selected simultaneous optimization input constraints comprises:
iteratively adjusting, as a price pair, each of a transfer price and a retail price;
determining, for each iteration of the adjustment of each of the transfer price and the retail price as the price pair, whether the mutual optimization goal of each of the at least two participants of the supply chain has been maximized at the adjusted transfer price and retail price; and
selecting one price pair of the iteratively adjusted transfer price and retail price that maximize the mutual optimization goal within the selected simultaneous optimization input constraints.

4. The method of claim 3, where:
the selected simultaneous optimization input constraints comprise pricing rules that comprise pricing rule relaxation criteria that specify a degree of flexibility in rule compliance during situations of pricing rule conflict; and
performing the requested simultaneous retail and transfer price optimization using the selected simultaneous optimization input constraints comprises:
determining, as part of each iteration of the simultaneous retail and transfer price optimization, whether the pricing rules are satisfied by the price pair of the adjusted transfer price and retail price; and
relaxing, in response to determining that at least one pricing rule is not satisfied by the price pair of the adjusted transfer price and retail price, the at least one pricing rule using the pricing rule relaxation criteria.

5. The method of claim 1, further comprising:
calculating projected sales values based upon the simultaneous retail and transfer price optimization; and
where generating the output that identifies the determined set of optimized values of the mutual optimization goal further comprises generating output of the calculated projected sales values.

6. The method of claim 1, where the set of optimized values comprises:
a transfer price optimized to increase the mutual optimization goal of a franchisor; and
a retail price optimized to increase the mutual optimization goal of a franchisee.

7. The method of claim 1, where the mutual optimization goal comprises one of:
a maximized profit for each of a franchisor and a franchisee;
a maximized revenue for each of the franchisor and the franchisee; and
a maximized sales volume for each of the franchisor and the franchisee.

8. A system, comprising:
a memory that stores simultaneous optimization input constraints; and
a processor programmed to:
receive a request for a simultaneous retail and transfer price optimization, where the request for the simultaneous retail and transfer price optimization comprises a mutual optimization goal of each of at least two participants of a supply chain;
select the simultaneous optimization input constraints from the memory based upon the mutual optimization goal;
perform the requested simultaneous retail and transfer price optimization using the selected simultaneous optimization input constraints;
determine, based upon the simultaneous retail and transfer price optimization using the selected simultaneous optimization input constraints, a set of optimized values of the mutual optimization goal, where each value of the set of optimized values is associated with one of the at least two participants of the supply chain; and
generate output that identifies the determined set of optimized values of the mutual optimization goal.

9. The system of claim 8, where, in being programmed to select the simultaneous optimization input constraints from the memory based upon the mutual optimization goal, the processor is programmed to:
obtain current prices of both a transfer price and a retail price;
obtain statistical model constraints applicable to the mutual optimization goal;
obtain a set of pricing rules to be enforced during the simultaneous retail and transfer price optimization of prices across the supply chain; and
obtain pricing rule priorities and pricing rule relaxation criteria.

10. The system of claim 8, where, in being programmed to perform the requested simultaneous retail and transfer price optimization using the selected simultaneous optimization input constraints, the processor is programmed to:
iteratively adjust, as a price pair, each of a transfer price and a retail price;
determine, for each iteration of the adjustment of each of the transfer price and the retail price as the price pair, whether the mutual optimization goal of each of the at least two participants of the supply chain has been maximized at the adjusted transfer price and retail price; and
select one price pair of the iteratively adjusted transfer price and retail price that maximize the mutual optimization goal within the selected simultaneous optimization input constraints.

11. The system of claim 10, where:
the selected simultaneous optimization input constraints comprise pricing rules that comprise pricing rule relaxation criteria that specify a degree of flexibility in rule compliance during situations of pricing rule conflict; and
in being programmed to perform the requested simultaneous retail and transfer price optimization using the selected simultaneous optimization input constraints, the processor is programmed to:
determine, as part of each iteration of the simultaneous retail and transfer price optimization, whether the pricing rules are satisfied by the price pair of the adjusted transfer price and retail price; and
relax, in response to determining that at least one pricing rule is not satisfied by the price pair of the adjusted transfer price and retail price, the at least one pricing rule using the pricing rule relaxation criteria.

12. The system of claim 8, where the processor is further programmed to:
calculate projected sales values based upon the simultaneous retail and transfer price optimization; and
where, in being programmed to generate the output that identifies the determined set of optimized values of the mutual optimization goal further, the processor is programmed to generate output of the calculated projected sales values.

13. The system of claim 8, where:
the set of optimized values comprises:
a transfer price optimized to increase the mutual optimization goal of a franchisor; and
a retail price optimized to increase the mutual optimization goal of a franchisee; and
the mutual optimization goal comprises one of:
a maximized profit for each of the franchisor and the franchisee;
a maximized revenue for each of the franchisor and the franchisee; and
a maximized sales volume for each of the franchisor and the franchisee.

14. A computer program product, comprising:
a computer readable storage medium having computer readable program code embodied therewith, where the computer readable program code when executed on a computer causes the computer to:
receive a request for a simultaneous retail and transfer price optimization, where the request for the simultaneous retail and transfer price optimization comprises a mutual optimization goal of each of at least two participants of a supply chain;
select simultaneous optimization input constraints based upon the mutual optimization goal;
perform the requested simultaneous retail and transfer price optimization using the selected simultaneous optimization input constraints;
determine, based upon the simultaneous retail and transfer price optimization using the selected simultaneous optimization input constraints, a set of optimized values of the mutual optimization goal, where each value of the set of optimized values is associated with one of the at least two participants of the supply chain; and
generate output that identifies the determined set of optimized values of the mutual optimization goal.

15. The computer program product of claim 14, where, in causing the computer to select the simultaneous optimization input constraints based upon the mutual optimization goal, the computer readable program code when executed on the computer causes the computer to:
obtain current prices of both a transfer price and a retail price;
obtain statistical model constraints applicable to the mutual optimization goal;
obtain a set of pricing rules to be enforced during the simultaneous retail and transfer price optimization of prices across the supply chain; and
obtain pricing rule priorities and pricing rule relaxation criteria.

16. The computer program product of claim 14, where, in causing the computer to perform the requested simultaneous retail and transfer price optimization using the selected simultaneous optimization input constraints, the computer readable program code when executed on the computer causes the computer to:
iteratively adjust, as a price pair, each of a transfer price and a retail price;
determine, for each iteration of the adjustment of each of the transfer price and the retail price as the price pair, whether the mutual optimization goal of each of the at least two participants of the supply chain has been maximized at the adjusted transfer price and retail price; and
select one price pair of the iteratively adjusted transfer price and retail price that maximize the mutual optimization goal within the selected simultaneous optimization input constraints.

17. The computer program product of claim 16, where:
the selected simultaneous optimization input constraints comprise pricing rules that comprise pricing rule relaxation criteria that specify a degree of flexibility in rule compliance during situations of pricing rule conflict; and
in causing the computer to perform the requested simultaneous retail and transfer price optimization using the selected simultaneous optimization input constraints, the computer readable program code when executed on the computer causes the computer to:
determine, as part of each iteration of the simultaneous retail and transfer price optimization, whether the pricing rules are satisfied by the price pair of the adjusted transfer price and retail price; and
relax, in response to determining that at least one pricing rule is not satisfied by the price pair of the adjusted transfer price and retail price, the at least one pricing rule using the pricing rule relaxation criteria.

18. The computer program product of claim 14, where the computer readable program code when executed on the computer further causes the computer to:
calculate projected sales values based upon the simultaneous retail and transfer price optimization; and
where, in causing the computer to generate the output that identifies the determined set of optimized values of the mutual optimization goal further, the computer readable program code when executed on the computer causes the computer to generate output of the calculated projected sales values.

19. The computer program product of claim 14, where the set of optimized values comprises:
a transfer price optimized to increase the mutual optimization goal of a franchisor; and
a retail price optimized to increase the mutual optimization goal of a franchisee.

20. The computer program product of claim 14, where the mutual optimization goal comprises one of:
a maximized profit for each of a franchisor and a franchisee;
a maximized revenue for each of the franchisor and the franchisee; and
a maximized sales volume for each of the franchisor and the franchisee.
